(19) United States
(12) Patent Application Publication
(10) Pub. No.: US 2012/0267935 A1
(43) Pub. Date: Oct. 25, 2012

(54) ONE-PIECE SEAT STRUCTURES AND METHOD OF FORMING

(75) Inventors: Omela Zekavica, Novi, MI (US); Daniel James Sakkinen, Highland, MI (US); Youzhi Xiong, Northville, MI (US); John David Kotre, Ann Arbor, MI (US); Anthony Kestian, Highland, MI (US); Robert J. Hicks, Plymouth, MI (US); Nicholas Leonard Petouhoff, South Lyon, MI (US); Antoine A. Kmeid, Canton, MI (US); Phillip Wayne Wilson, Wixom, MI (US); David Hayes, West Bloomfield, MI (US); Miodrag M. Petrovich, Plymouth, MI (US); Elizabeth Ann Allen, Ypsilanti, MI (US); Catherine M. Amodeo, Livonia, MI (US); Andrew J. Erard, Ceresco, MI (US); Mark S. Williamson, Plymouth, MI (US); Forest Hills, Plymouth, MI (US); Joseph F. Prosniewski, Brownstown Township, MI (US)

(73) Assignee: Johnson Controls Technology Company, Holland, MI (US)

(21) Appl. No.: 13/387,269

(22) PCT Filed: Jul. 27, 2010
(86) PCT No.: PCT/US10/43391

§ 371 Date: Jul. 10, 2012

Related U.S. Application Data
(60) Provisional application No. 61/228,836, filed on Jul. 27, 2009.

(51) Int. Cl. B60N 2/68; B23P 11/00

(52) U.S. Cl. 297/452.18; 29/428

(57) ABSTRACT

A one-piece seat back frame for use in a vehicle seat assembly including a first side portion, a second side portion, an upper cross portion, a lower cross portion coupled together to form a rectangular unitary frame structure. The seat back frame also includes an inner wall extending from a front surface and an inner edge of the back frame, and an outer wall extending from the front surface and an outer edge of the back frame, thereby forming a channel on the front surface. A plurality of formations are formed in the back frame to enhance the strength and stiffness of the back frame. The seat back frame also includes a plurality of apertures for attaching other seat components, such as a head restraint assembly. The seat back frame is formed from at least one of a monolithic blank, a tailored welded blank, and/or a tailored welded coil.

### CROSS REFERENCE TO RELATED APPLICATIONS

This application claims the benefit of and priority to U.S. Provisional Application No. 61/228,836, filed Jul. 27, 2009, which is incorporated herein by reference.

### BACKGROUND

The present disclosure relates generally to vehicle seats and more particularly, seat structures for use in a seat frame and processes for forming same.

### DESCRIPTION OF THE RELATED ART

Seat structures, such as, seat back frames, seat base cushion frames, low seat structures, back frame seat belt towers, or the like, can provide strength to a seat assembly to meet strength and durability requirements that are commonly covered by governmental regulations, such as, FMVSS, ECE, or the like; or suggested and/or dictated by other groups, such as, by vehicle manufacturers, insurance groups, or the like. Seat structures also can be configured to meet the desires of customers and hence vehicle manufacturers for seat assemblies that provide increased functionality or utility, such as, rotating, folding, sliding, or the like, while improving user-adjustable comfort. Achieving the desired structural characteristics, such as, strength, stiffness, durability, or the like; functional characteristics, and utility characteristics typically requires the use of additional components which can have an undesirable impact on mass, cost, and comfort. Seat structures are typically designed by balancing structural and functional characteristics against mass, comfort, and cost.

It is generally known to construct a seat structure by separately forming individual members through a conventional stamping process, such as, a progressive or transfer die, or the like; and then coupling those formed members using another process to accomplish their joining, such as, a welding process (e.g., laser welding, gas metal arc welding (GMAW), etc.), mechanical joining, gluing, or the like. This method of construction has several disadvantages, at least some of which are as follows. First, the welding process which is the most common method for joining formed metal components, especially laser welding, requires tight tolerances with respect to parameters (e.g., gap, profile tolerances, etc.) to produce a reliable structural weld, which can require increasing complexity of the forming process (e.g., adding steps to allow tool action for additional tolerance control) and/or complex welding fixtures. Second, concerns about reduced reliability resulting from the need to hold tight tolerances may cause manufacturers to couple the member with redundant welds to increase reliability, which adds to piece cost and cycle time of manufacture. Third, individual tools may be required to produce each individual member, which adds to piece cost and maintenance cost and may not provide an opportunity to be reused, since customers are also asking for their unique frame shapes and performances. Fourth, a higher number of individual members used to construct a seat structure results in higher likelihood that the lack of one member will stop the entire production process of a seat structure. Fifth, this method of construction requires significant part handling downstream in the manufacture process, which adds to the piece cost. Sixth, this method of construction can inhibit optimization of mass and strength. For example, to reduce costs of parts having individual members shared between different seat structures, the design for the shared member is driven by requirements that can cause manufacturers to structurally overdesign portions of the seat structure to achieve part reduction. Seventh, some conventional methods of coupling (e.g., GMAW, fasteners, etc.) require overlaps and/or the addition of material, such as extra parts or filler material, which negatively impacts mass and cost. Eighth, the coupling of multiple individual stamped members typically requires a significant number of joints, welds, or the like. For example, a conventional four member back frame structure may require more than twenty welds to couple the members into one frame assembly. The need for this high quantity of welds in combination with weld fixtures (e.g., a rotating carousel fixture, etc.) results in slow manufacturing cycle times.

Accordingly, there is a need to design and form structural components with reduced mass and reduced cost, while meeting or exceeding increased strength and durability requirements. Additionally, because the structural components of a seat assembly of a vehicle provide safety related functionality, there is always a need to increase reliability of the processes and components that are in the load path during a dynamic vehicle impact event. There is also a need for additional functionality with a minimal impact on comfort, mass, and cost. Additionally, the cost to handle or modify the component increases significantly as a product moves downstream in its manufacturing cycle, hence there is a desire to reduce or eliminate downstream operations.

### SUMMARY

Accordingly, the present disclosure relates to a one-piece seat structure for use in a vehicle seat assembly. A one-piece seat back frame for use in a vehicle seat assembly including a first side portion, a second side portion, an upper cross portion, a lower cross portion coupled together to form a rectangular unitary frame structure. The seat back frame also includes an inner wall extending from a front surface and an inner edge of the back frame, and an outer wall extending from the front surface and an outer edge of the back frame, thereby forming a channel on the front surface. A plurality of formations are formed in the back frame to enhance the stiffness of the back frame. The seat back frame also includes a plurality of interfaces for attaching other seat components, such as a head restraint assembly or seat back mechanism assemblies as recliners. Some components of these attaching assemblies can be incorporated into main one-piece back frame, such a recliner retainer ring or headrest rod holder, or the like. The seat back frame is formed from a monolithic blank of sheet metal and/or coil, a tailored welded blank, and/or a tailored welded coil.

Also provided is a one-piece seat structure for use in a vehicle seat assembly made from a tailor welded blank or coil. The one-piece seat structure includes a first portion formed from a first material grade and having a first material thickness, and a second portion formed from a second material grade and having a second material thickness. The first and second portion are coupled together to form a tailor welded blank or coil while the material is in a flat-sheet state and the one-piece seat structure is formed from the tailor welded blank or coil using a cold-forming process. The one-piece seat structure also includes a plurality of formations formed in the seat structure to stiffen the seat structure or to provide an interface for attaching other seat assemblies or mechanisms.

Also provided is a method of forming a one-piece seat structure. The method includes the step of providing a first portion of material formed from a first material grade and having a first material thickness, providing a second portion of material formed from a second material grade and having a second material thickness, forming a tailor welded blank or coil by coupling the first portion to the second portion, and forming the one-piece seat structure from the tailor welded blank using a cold-forming process. The method also includes the step of forming a plurality of formations in the seat structure to stiffen the seat structure. The method also includes the step of forming the one-piece seat structure from one of a tailored welded coil, a tailored welded blank, or a monolithic blank or coil having uniform material grade and thickness using a forming process, such as a cold forming process.

An advantage of the present disclosure is that the seat structures of the present disclosure have reduced mass while meeting or exceeding strength, stiffness and durability requirements. Another advantage of the present disclosure is that the seat structures of the present disclosure are easier to manufacture and thus less costly to manufacture. A further advantage of the present disclosure is that the one-piece structure enables flexibility related to shapes, dimensions, interfaces and strength and stiffness requirements to be met with optimal choice of material grade, material thickness and geometry.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle, according to an exemplary embodiment.

FIG. 2 is a perspective view of a seat assembly, according to an exemplary embodiment.

FIG. 3 is a flow diagram illustrating examples of manufacturing processes for producing an exemplary seat structure.

FIG. 4A is a front view of a tailored welded blank for forming a seat structure (such as a one-piece seat back structure) for use with a seat assembly, according to an exemplary embodiment.

FIG. 4B is a perspective view of a one-piece seat back structure, according to an exemplary embodiment.

FIG. 4C is an alternative cross-sectional view of the one-piece seat back structure of FIG. 4B, taken along the areas corresponding to lines A-A and B-B in FIGS. 4A and 4B.

FIG. 5 is a front view of another tailored welded blank for forming a seat structure (such as a one-piece seat back structure) for use with a seat assembly, according to an exemplary embodiment.

FIG. 6 is a perspective view of a one-piece seat back structure, according to an exemplary embodiment.

FIG. 7 is a perspective view of a seat back structure constructed from multiple individually formed components, according to an exemplary embodiment.

FIG. 8A is a front view of portions of another tailored welded blank for forming a seat structure (such as a one-piece seat back structure), prior to joining the portions, for use with a seat assembly, according to an exemplary embodiment and prior to cold forming.

FIG. 8B is a front view of the tailored welded blank of FIG. 8A, after joining the portions through a joining process, such as laser welding.

FIG. 8C is a front view of the tailored welded blank of FIG. 8B, including a pre-form in the side member portions.

FIG. 8D is a front view of the tailored welded blank of FIG. 8C, illustrating the location of the bending lines from the forming process.

FIG. 8E is a perspective view of the tailored welded blank of FIG. 8A through 8C, post forming, illustrating the improved sectional properties local to typically high stress regions.

FIG. 8F is a front view of another tailored welded blank for forming a seat structure (such as a one-piece seat back structure), for use with a seat assembly, according to an exemplary embodiment prior to forming.

FIG. 9 is perspective view of a seat base structure, according to an exemplary embodiment.

FIG. 10 is a perspective view of seat base bracket assemblies, according to an exemplary embodiment.

FIG. 11 is a perspective view of a seat base cushion pan, according to an exemplary embodiment.

FIG. 12 is a perspective view of another embodiment of a seat base cushion pan, according to an exemplary embodiment.

FIG. 13 is a perspective view of a riser structure, according to an exemplary embodiment.

FIG. 14 is a perspective view of a two occupant seat back structure, according to an exemplary embodiment.

FIG. 15 is a perspective view of a pivotable two occupant seat base structure, according to an exemplary embodiment.

FIG. 16 is a perspective view of a back frame, according to an exemplary embodiment.

FIG. 17 is partial front and rear perspective view of the back frame of FIG. 16.

FIG. 18 is a rear, side and perspective view of the back frame of FIG. 16 under rearward loading.

FIG. 19 is a front and rear perspective view of a topography optimized one-piece back frame, according to an exemplary embodiment.

FIG. 20 is a graph comparing the performance of a back frame according to the exemplary embodiment compared to a topography optimized back frame.

FIG. 21 is a front isometric view of a one-piece cold formed back frame, according to an exemplary embodiment.

FIG. 22 is a rear isometric view of a one-piece cold formed back frame, according to an exemplary embodiment.

FIG. 23 is a front view of a one-piece cold formed back frame, according to an exemplary embodiment.

FIG. 24 is a side view of a one-piece cold formed back frame, according to an exemplary embodiment.

FIG. 25 is a front perspective view of the one-piece back frame, according to another embodiment.

FIG. 26 is a rear perspective view of the one-piece back frame of FIG. 26.

FIG. 27 is a side view of the one-piece back frame of FIG. 26.

FIG. 28 is a front view of the one-piece back frame of FIG. 26.

FIG. 29 is a rear view of the one-piece back frame of FIG. 26.

FIG. 30 is a top view of the one-piece back frame of FIG. 26.

FIG. 31 is a bottom view of the one-piece back frame of FIG. 26.

FIG. 32 is a cross-sectional view of the one-piece back frame of FIG. 26 taken along line A-A.

FIG. 33 is a rear perspective view of the one-piece back frame of FIG. 26 including a head restraint attachment assembly, according to another embodiment.

FIG. 34 is a front perspective view of the one-piece back frame of FIG. 34.

FIG. 35 is a rear perspective view of a one-piece back frame including a head restraint attachment assembly and one option for enhancing side impact loading performances, according to another embodiment.

FIG. 36 is a front perspective view of the one-piece back frame of FIG. 36.

### DESCRIPTION

Referring generally to the FIGURES, a one-piece seat structure 5 for use within a seat assembly 12 of a motor vehicle 10 and a process for forming the seat structure 5 is illustrated. A one-piece seat structure 5 can be configured to achieve various characteristics, for example, desired strength, durability, functionality, utility, mass, cost, and/or user comfort.

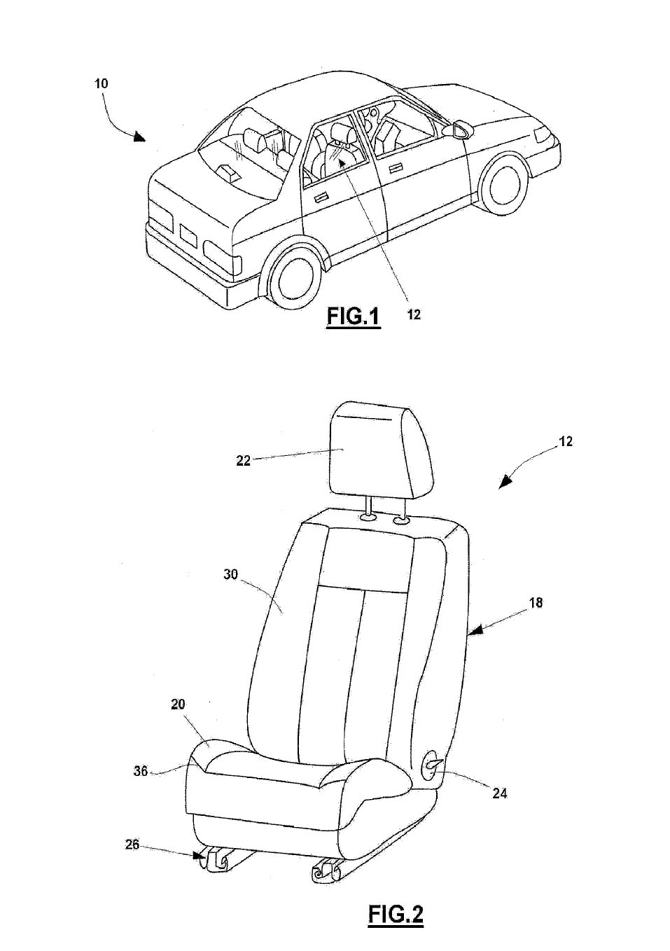

Referring to FIG. 1, a vehicle 10 having a seat is shown. The vehicle 10 can include one or more seat assemblies 12 provided for occupant(s) of the vehicle 10. While the vehicle 10 shown is a four door sedan, it should be understood that the seat assembly 12 may be used in a mini-van, sport utility vehicle, airplane, boat, or any other type of vehicle.

Referring now to FIG. 2, a seat assembly 12 is shown. The seat assembly 12 can include a seat back 18 to provide comfort, support and protection to the seated occupant. A seat cushion (base) 20 is operatively connected to the seat back, and likewise provides comfort, support and protection to the seated occupant. A head restraint 22 is positioned at an upper end of the seat back. The seat assembly 12 includes a recliner mechanism 24 operatively connected to the seat back and seat cushion, to provide rotatable adjustability of the seat back 18 with respect to the seat cushion 20. The seat assembly is secured to the vehicle using and a track assembly 26, The track assembly of this example provides for adjustability or movement of the relative position of the seat assembly for comfort or utility of the seated occupant. The seat back 18 can include, for example, a foam pad 28, a trim cover 30, and a one-piece seat back structure 32. The seat cushion 20 can include, for example, a foam pad 34, a trim cover 36, and a one-piece seat cushion structure 38. The seat assembly 12 illustrated is a one-occupant seat typically used in the front row of a vehicle, but a one-piece structure 5 may be incorporated into any seat assembly, such as, a second row bench, a third row fold flat seat, or the like, which may utilize any type of seat functionality for use within any vehicle.

FIG. 3 is a flow diagram illustrating a method or process of constructing a seat structure, such as the one-piece seat structure 5 of this example. The process begins at step 500 with a starting phase for preparing process materials, such as, sheet coil material. The methodology advances to step 502, and a phase for adding value to the material, such as, sheet metal is initiated. The methodology advances to step 504 and a phase for forming a net/near net shape is initiated. The methodology advances to step 506 and a phase for forming an optional post forming operations is initiated. and the methodology advances to step 508 and completes the final one-piece structure. In overview, a blank 40, such as, a tailored welded blank 16, or the like, can be constructed by, for example, using conventional means, such as, laser welding, or the like, to couple two or more portions 42, such as, steel portions, or the like, into one of the following: (a) a shape that directly creates the blank 40; or (b) a length of material 44 that can be rolled into a coil of material 46 that is processed to form the blank 40. The blank 40 can then be formed by a forming process 48, such as, a cold-forming process, or the like, to produce the one-piece seat structure 5, such as, a one-piece seat back frame 32, or the like. Optionally, post-forming or secondary operations 52 can be performed after the initial forming process 48 to provide additional features that enhance function or performance, and to provide improved properties, characteristics, configurations, or the like. These post-forming or secondary operations 52 can include operations, such as, partial heat treatment for added strength, or the like. This process can also be utilized when utilizing monolithic material blanks or coils.

The tailored welded blank 16 can be constructed by coupling the portions 42 directly into the shape of the blank 16 by using any of various suitable techniques. For example, the portions 42 can be obtained by cutting sections 54 of desired size and shape from one coil of sheet material 46 or from multiple coils of sheet material 46 (e.g., wherein the properties of the sheet material are uniform on each given coil, but differ from one coil to the next). The portions 54 cut from the coil(s) 46 then can be positioned in a desired configuration and coupled together to form the tailored welded blank 16, which will then be shaped using the cold-forming process. Tailored welded blanks 16 can be configured in a variety of ways, for example, varying the shape, size, quantity, material, and thickness of the portions 54, as well as varying the relative positions of different portions prior to coupling.

Alternatively, a portion cut from the coil 54 (e.g., portion made from different materials with different material thicknesses, etc.) can be coupled together, such as by laser welding or the like, and then rolled again into a single coil of steel to form a tailored welded coil 56 having material of different properties along its width. The tailored welded coil 56 can then be partially unrolled, a section 58 cut therefrom, and the section 58 can be trimmed by any appropriate technique to form an entire tailored welded blank 16. As another alternative, sections 58 can be cut from the tailored welded coil 56 and possibly other coils, and those sections 58 can then be positioned in a desired configuration and coupled together to form the tailored welded blank 16, which will then be shaped using the cold-forming process. Another alternative would be to continuously feed a tailored welded coil 56 directly into a die 60 (e.g., progressive or transfer die) to form a tailored component 62. Blanks 16 formed from tailored welded coils 56 can be configured in a variety of ways by, such as by varying the coil 56 strip widths, varying the shape, size, quantity, material, and/or thickness of the portions 42, as well as varying the relative position of different portions 42 prior to coupling.

A tailored welded blank 16 formed in accordance with the present disclosure offers the ability to, for example, integrate components, minimize scrap, reduce handling, reduce cost and optimize strength and mass. For example, mass and cost can be optimized by flexibly optimizing the material (i.e., mechanical properties) and thickness at differing sections of a tailored welded blank 16 to meet strength and manufacturing requirements. The tailored welded blank 16 can then be formed through a cold-forming process to produce a one-piece structural component 5, which may have complex geometry yet require fewer secondary operations and less expensive fixtures or tooling. The one-piece seat structure 5 can be optimized for cost and mass, which meets or exceeds strength and durability requirements and the strength and durability of conventional seat structures. The mass reduction of seat components can have a ripple effect for vehicle manufacturers, as mass reduction affects the design of other components, such as, brakes, powertrain, or the like. This mass reduction also enables the incorporation of other components that have lower mass, smaller size, more efficient, or the like, which can lead to other cost savings in the vehicle 10.

The portions 42 that are coupled to form the tailored welded blank 16 (or to form the tailored welded coil 56 that ultimately becomes the tailored welded blank 16) can have different characteristics. For example, the portions 42 may be made from different materials and/or they may have different thicknesses. Tailored welded blanks 16 are flexible in regard to varying the properties, such as, blank size, shape, mechanical properties, thickness, or the like, of the different portions 42 to be coupled, which optimizes the mass and structural characteristics of the one-piece structure 5 by allowing each portion 42 to be designed to meet a specific strength. Tailored welded blanks 16 reduce part cost by minimizing scrap through more efficient nesting of the portions 42, and tooling cost by requiring simpler and/or less tooling, than conventional seat structures, to achieve reliable welds. The tooling of tailored welded blanks 16 may be simpler and less expensive, because the blanks 16 being coupled are not formed prior to coupling, thus have more dimensionally stable coupling features which allows for less complex or less expensive fixtures to achieve the necessary joining or weld parameters (e.g., gap, etc.) to produce a reliable weld. This increase in weld reliability also allows for the reduction of redundant welds, which further reduces cost and cycle time. The more mass-optimized tailored welded blank 16 may be cold formed (i.e., pressed between tooling at conventional ambient temperature) to form a mass and cost optimized one-piece seat structure 5. The one-piece seat structure 5 may require fewer secondary operations than conventional structures, as the tooling may produce complex geometry, which significantly reduces the handling as compared to conventional structures.

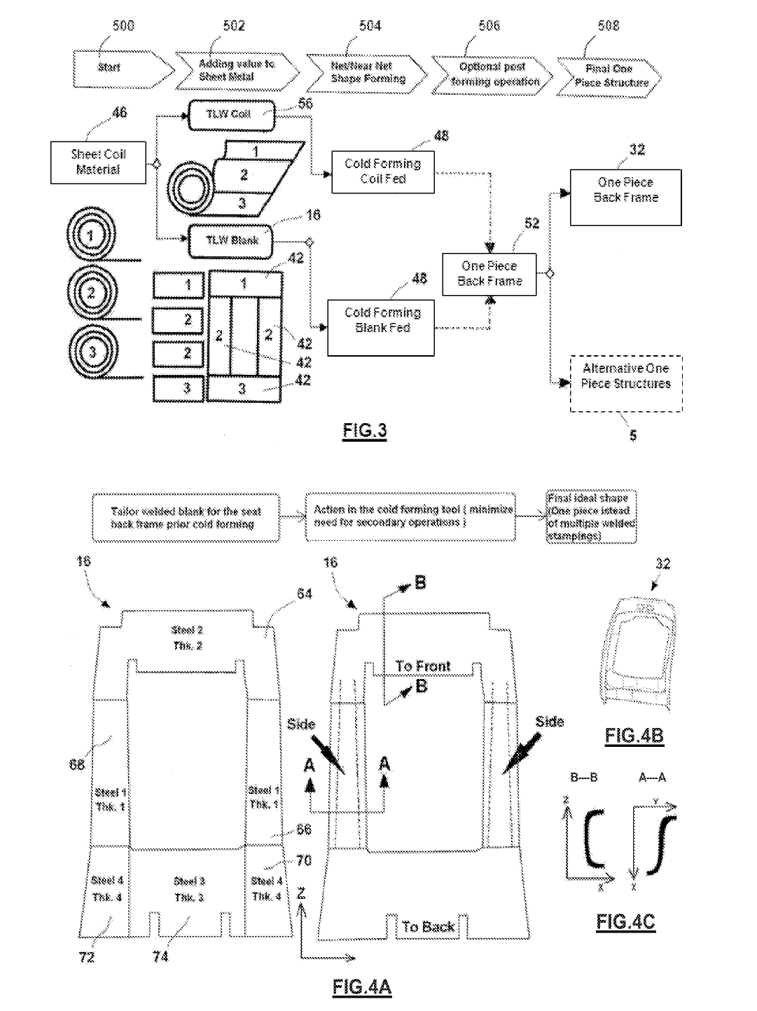

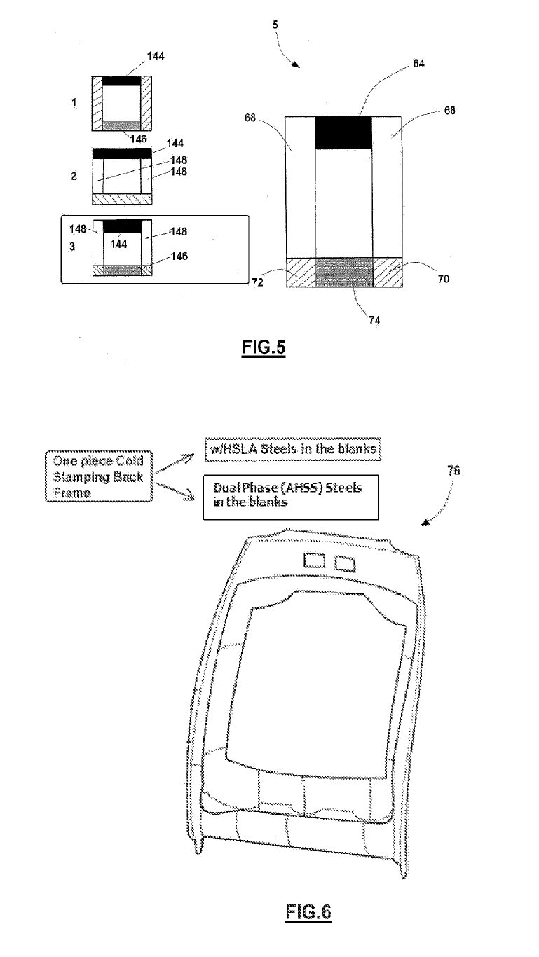

Referring to FIGS. 4A through 5, examples of a tailored welded blank 16 for use in constructing a one-piece seat back structure 32 are shown. Accordingly, the tailored welded blanks 16 each include six portions (P1-P6) 64, 66, 68, 70, 72, 74, though the number of portions can be more or less depending on a variety of factors, such as cost to weld, material costs, performance requirements, etc. The portions can have a variety of characteristics that differ from one another. For example, portions two 66 and three 68 can be made from a first steel type and have a first thickness, portion one 64 can be made from a second steel type and have a second thickness, portion six 74 can be made from a third steel type and have a third thickness, and portions four 70 and five 72 can be made from a fourth steel type and have a fourth thickness. for example, portion one (P1) 64 can be made from medium grade (420 MPa yield strength) high strength low-alloy (HSLA) steel that is 0.8 mm thick. Portions two and three (P2 and P3) 66, 68 can be made from medium grade HSLA steel that is 0.955 mm thick. Portions four and five (P4 and P5) 70, 72 can be made from high grade (550-1000 MPa yield strength) HSLA steel that is 1.0 mm thick. Portion six (P6) 74 can be made, from low grade (340 MPa yield strength) HSLA steel that is 0.9 mm thick.

It should be noted that these materials and thicknesses are merely shown as examples, and they can be modified as appropriate. One of the options is to replace High Strength Low Alloy (HSLA) steels, know as High Strength Steels (HSS) with Advance High Strength Steels (AHSS), as Dual Phase (DP) or Complex Phase (CP) steels to take advantage of their enhanced steel characteristics as high yield and ultimate strength for relatively high elongations and high work hardening rates. Other categories of steels that provide enhanced forming characteristics as TWP and TRIP are also possible. Another option is to utilize post form heat treatable steels where secondary operation can provide increases of strength while a part is formed at the basic stage of material when it has a high forming ability. The same strategies can be applied in the case of a monolithic blank or coil as well.

FIG. 5 shows three exemplary options for constructing a one-piece seat structure 5 (e.g., one-piece seat back frame 32, etc.) from two or more different types of material (e.g., steel one 144, steel two 146, and steel three 148, etc.). For example, according to option three, the one-piece seat structure 5 may be constructed from six portions having different material properties. These properties may be identified within grades of different High Strength Steels (HSS) as SAE J2340 340, 420 or 550 XF with different thicknesses or Advance High Strength Steels (AHSS) as Dual Phase (DP) or Complex Phase Steels (CPS) with appropriate thickness. Utilizing AHSS enables using thinner gauges of material to accomplish stiffness performances requirements and therefore mass savings in the seat structure. Using option three provides the most material placement vise flexible which provides more opportunity for mass reduction. The same strategy can be applied if the coil or blank is made of a monolithic material.

The multiple portions (P1 through P6) 64, 66, 68, 70, 72, 74 are coupled through a conventional process (e.g., laser welding, etc.) into a tailored welded blank 16 prior to forming. The simple geometry of each portion improves weld reliability, by having more dimensionally stable weld features (e.g., gap, etc.), and decreases tooling cost, by allowing for less complex tooling which would be required to compensate for a less dimensionally stable part. The conventional method of coupling components post forming drives this dimensional instability and requires more expensive fixtures to assure reliable welds. The increased weld reliability of tailored welded blanks 16 allows for the elimination of redundant welds, which are required on conventional structures due to the less reliable welds. An exemplary tailored welded blank 16 comprising of six portions may be coupled with six welds, while another embodiment of a tailored welded blank 16 comprising of four portions may be coupled with four welds, which is a significant improvement over conventional four member back frame that could have more than twenty welds. The tailored welded blank 16 also has an improved nesting, which reduces scrap and cost.

FIG. 4B shows an exemplary one-piece seat back structure 32 that may be cold formed from the tailored welded blank 16 of FIG. 4A, to be mass and cost optimized. This same one-piece structure can also be formed from a monolithic blank or coil having uniform material grade and thickness. The cold-forming produces a one-piece seat back structure 32 that has varying cross-sections, as shown in FIG. 4C, and has a complex geometry, which allows for coupling of other assemblies (e.g., head rest assembly 22, recliner assembly 24, stowable drive link, etc.) as required. A one-piece structure 5 may form a complex geometry efficiently, for example, the plurality of required holes may be formed (e.g., cut, pierced) by one station. This is in contrast to a conventional structure, which would require multiple stations in a progressive die to form them all. Additionally, a one-piece structure 5 may be formed in one die (e.g., transfer die, etc.), whereas a conventional structure would require multiple progressive dies, each comprising multiple stations to form the individual components, therefore reducing tooling costs. The reduction of mass by utilizing tailored welded blanks 16 may translate into a reduction of packaging space required by the one-piece cold formed seat structure 5. This reduction of packaging space allows for the seat assembly 12 to have an increased volume of low mass foam to improve comfort for the occupant, or to add feature(s) to increase the functionality or utility. The one-piece seat structure 5 produces a reduced mass and reduced cost seat assembly 12 with equal strength to a conventional seat assembly, which allows for an increase in comfort with little impact to the reduction of mass and cost, or allows for the inclusion of additional functionality to offset the reduction of mass and cost. The one-piece cold formed seat structure 5 also provides for a reduction in handling downstream, which further reduces cost in the form of eliminated labor for part handling and eliminated tooling. The one-piece seat structure 5 may also reduce the number of required fasteners downstream, by integrating separate components required by conventional methods.

It is contemplated that the number, position, and configuration of respective portions 42, as well as the properties (e.g., mechanical, thickness) of the respective portions 42, may be varied to, for example, satisfy specific design requirements e.g., cost, mass, strength or the like. FIGS. 4A thru 5 are merely illustrative of the flexibility of the one-piece structure 5 made from tailored welded blanks 16. This flexibility results in a seat structure component 5 which is mass, strength and cost optimized. This flexibility, with respect to material, allows the use of draw quality steels or transformation induced plasticity (TRIP) or twinning induced plasticity (TWIP) steels in the locations where there are high forming stresses, and allows the use of high strength steels (HSS) in the locations where there are high strength requirements.

FIG. 6 shows an example of a one-piece seat back structure 76 cold formed from the tailored welded blank 16 of FIG. 4a. The cold forming of the tailored welded blank 16 allows for the one-piece seat back structure 76 to have varying cross-sections and complex geometry, with specific regions having unique materials designed to meet strength and formability requirements. The cold forming process is flexible and is not constrained by the materials specified, as they are merely illustrating the integration of what was conventionally multiple components into one complex component that can be optimized for mass and strength.

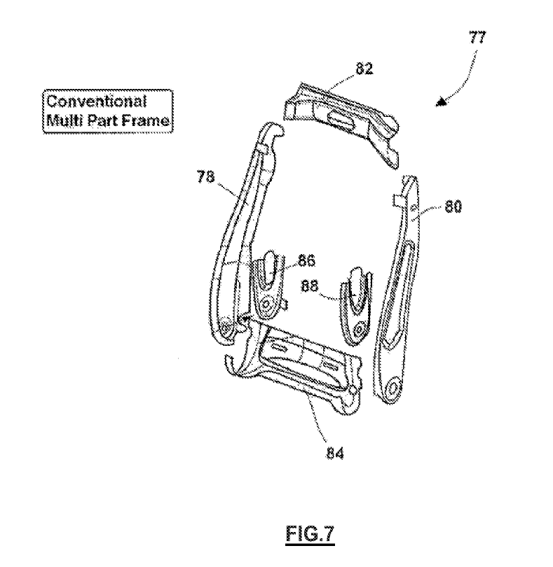

Referring now to both FIGS. 6 and 7, comparative advantages of a seat back frame 76 according to the present invention (FIG. 6) and a conventional seat back frame 77 (FIG. 7) are illustrated. The conventional seat back frame 77 (FIG. 7) can be constructed by coupling through conventional techniques (e.g., welding, etc.) multiple individually stamped parts, including two side members 78, 80, an upper cross member 82, a lower cross member 84, and two support members 86, 88. This conventional process often required the use of support components (S1 and S2) 86, 88 to be included in the construction of the seat back frame 77 to meet the required strength. The alternative is to over-design the side members 78, 80 to accommodate the need to have an increase in strength only in the lower portion of each side member 90, 92. Either conventional method resulted in additional mass and cost (in the form of both piece cost and labor cost). The conventional method of constructing a seat structure involved significant amounts of non-value added time for material handling and secondary operations. In contrast, the exemplary embodiment of the one-piece seat back structure 76 (FIG. 6) offers a mass reduction of approximately 22.7% while offering equal strength as the conventional multiple piece seat back structure of FIG. 7. This reduction is possible by using what are considered by the industry to be conventional (lower cost) materials such as HSLA steels. The flexibility of the one-piece seat structure 10 allows for the use, independently or in combination, of less conventional materials (e.g., high strength steels, ultra high strength steels, aluminum, magnesium, etc.), which have a higher cost, but present the opportunity to gain additional mass savings and also allows for use of those materials in combination with steel (in which case appropriate joining methods, e.g., brazing, cold metal transfer, steer welding, etc, may be considered). The illustrated alternative embodiment of FIG. 6 offers a mass reduction of approximately 28.3% while offering equal strength as the conventional multiple piece seat back structure. One-piece seat structures 5 are not limited by the use of the materials specified, by the number of portions, or by the geometry illustrated. Therefore the mass reduction of another embodiment is not limited to the numbers specified.

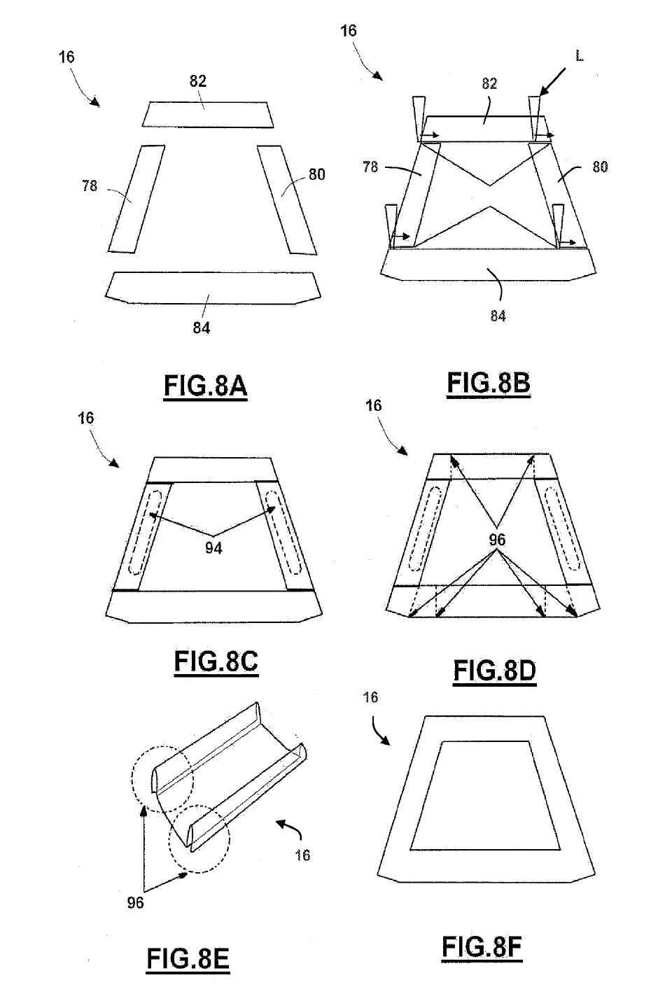

FIGS. 8A through 8E show another example of a tailored welded blank 16 and its use in constructing a one-piece seat back structure 32. In this example, the tailored welded blank 16 may be constructed of four portions comprising an upper member 82, a lower member 84, and two side members 78, 80, as shown in FIG. 8A. The two side members 78, 80 may come from the same coil of steel, differing from both the upper and lower member 82, 84, which each come from a unique coil of steel. For example, the upper member 82 may be made of a first material and first thickness, the first and second side members 78, 80 may be made from a second material and second thickness, and the lower member 84 may be made from a third material and third thickness. The portions may be coupled to each other via a joining process as previously described to form an exemplary tailored welded blank 16, as shown in FIG. 8B. An exemplary tailored welded blank 16 may have an initial form or pre-form 94, depending on the complexity of the end geometry, which is shown in FIG. 8C. The exemplary tailored welded blank 16 may then be cold formed, whereby the blank 16 undergoes bending about predetermined bending lines 96 (shown in FIG. 8D), to achieve the required strength by increasing the sectional properties (e.g., moment of inertia, etc.) of the one-piece structure 32 by having the member formed back over itself, wherein there are two material thicknesses in the localized area, as shown in FIG. 8E. Another example may have increased section properties by having the member formed back over itself more than once, wherein there are three or more material thicknesses in the localized area. The flexibility of the cold forming process allows for localized increased strength to efficiently manage the loads the one-piece structure will be subjected to in vehicle. This flexibility is useful in areas of high loading, for example, where recliner mechanisms 24 are coupled to a seat back structure 18. According to another embodiment, a blank can be made from a monolithic material tailored welded blank 16 may include a common material throughout. FIG. 8F shows a blank in one state of the forming process wherein the center of the blank is already removed to enable construction of the needed shape of the seat back frame.

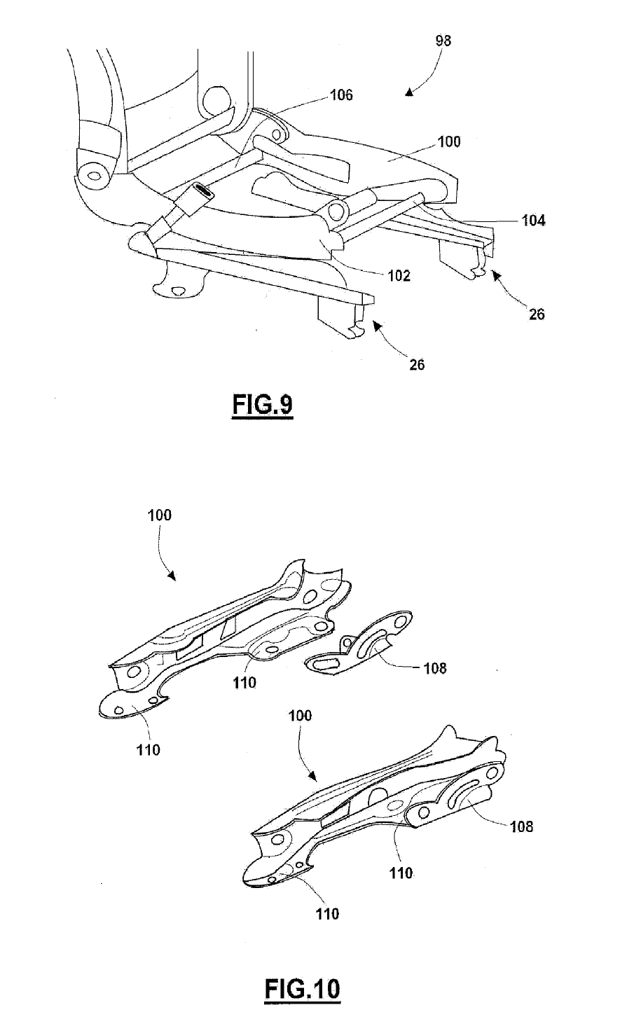

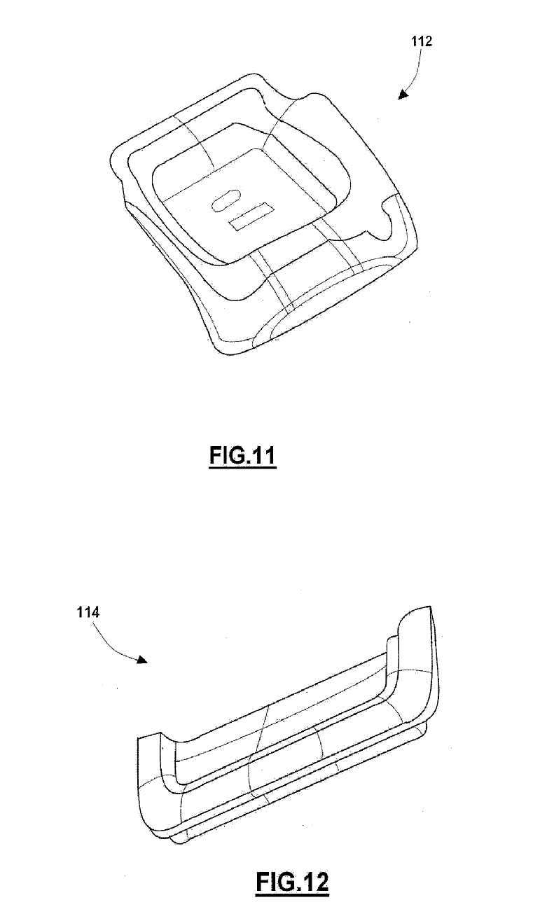

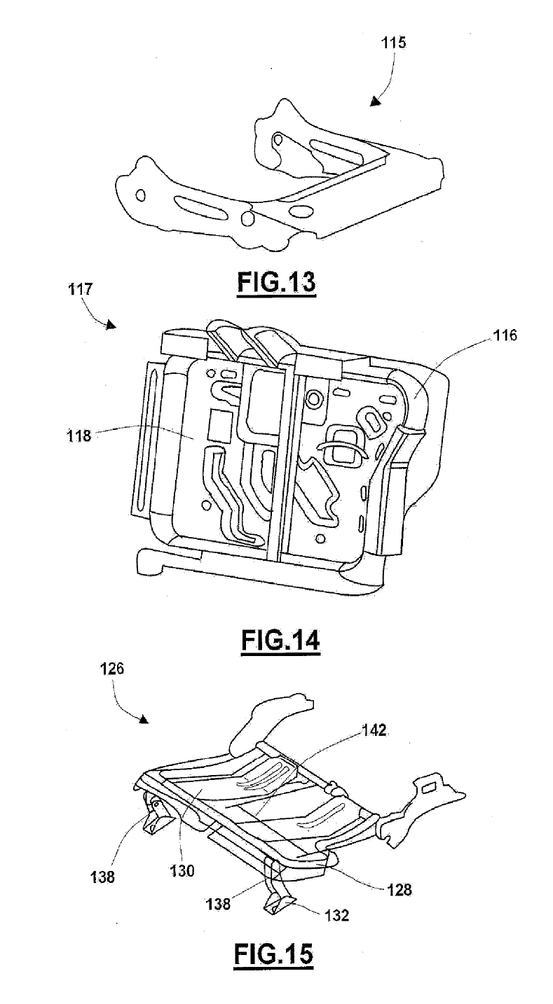

Referring to FIGS. 9 through 13, an example of other one-piece seat structures 5 examples of conventional seat structures, which represent opportunities to integrate into one-piece seat structures 5, are shown. FIG. 9 illustrates an exemplary embodiment of a first row seat base structure 98 which includes two base side brackets (“B-brackets”) 100, 102 two cross tubes 104, 106, at least one reinforcement bracket 108 (FIG. 10), and a plurality of members 110 to couple the base side brackets 100, 102 to the track assemblies 26 and to the cross tubes 104, 106. The one-piece seat structure 5 may be cold formed by integrating any combination of these components. FIG. 11 illustrates an example of a cushion pan 112 (e.g., first row seat base with full cushion pan) which is coupled above the side brackets 100, 102 to the first row seat base structure 98 of FIG. 9 and supports the foam of the seat cushion assembly 20. The cushion pan 112 may be integrated with the side brackets 100, 102 to form a one-piece seat structure 10 which is mass and cost optimized. FIG. 12 illustrates a half cushion pan 114 (e.g., first row seat base half cushion pan) typically used to increase the structural rigidity of a seat cushion 20, which may be integrated with other seat cushion components, for example the side brackets 100, 102 and reinforcement members of FIG. 10, to form an exemplary one-piece riser structure 115 as shown in FIG. 13.

Referring to FIG. 14, another example of a conventional seat back structure 117 to support multiple occupants is illustrated, and includes at least one formed tube 116, at least one back panel 118, a plurality of brackets 120 to attach a belt retractor assembly 122, a ultra high strength tower 124 to transfer the loads from the retractor 122, a plurality of mounting brackets 120 to connect to recliner mechanisms 24, and a plurality of brackets 120 to attach head-rest assemblies 22 to. This example provides significant opportunity to reduce mass and cost, by integrating components into a one-piece seat back structure 32 or multiple one-piece seat structures 5 to be coupled by a secondary operation.

Referring to FIG. 15, another example of a conventional pivotable seat cushion structure 126 to support multiple occupants is illustrated, and includes at least one formed tube 128, at least one cushion pan 130, a plurality of brackets 132 to attach to the floor of the vehicle 14, a means to pivot 134 the rear of the cushion structure 136, at least one front leg bracket 138 to pivot the front of the cushion 140 with respect to the floor mounting brackets 132, and a plurality of wire 142 to support the foam 34 and to attach trim 36. This example of a seat provides significant opportunity to reduce mass and cost, by integrating components into a one-piece seat cushion structure 38 or multiple one-piece seat structures 5 to be coupled by a secondary operation. Those skilled in the art will recognize the broad application of the ability to optimize seat structures by cold-forming one-piece structures 5 that include tailored welded blanks 16.

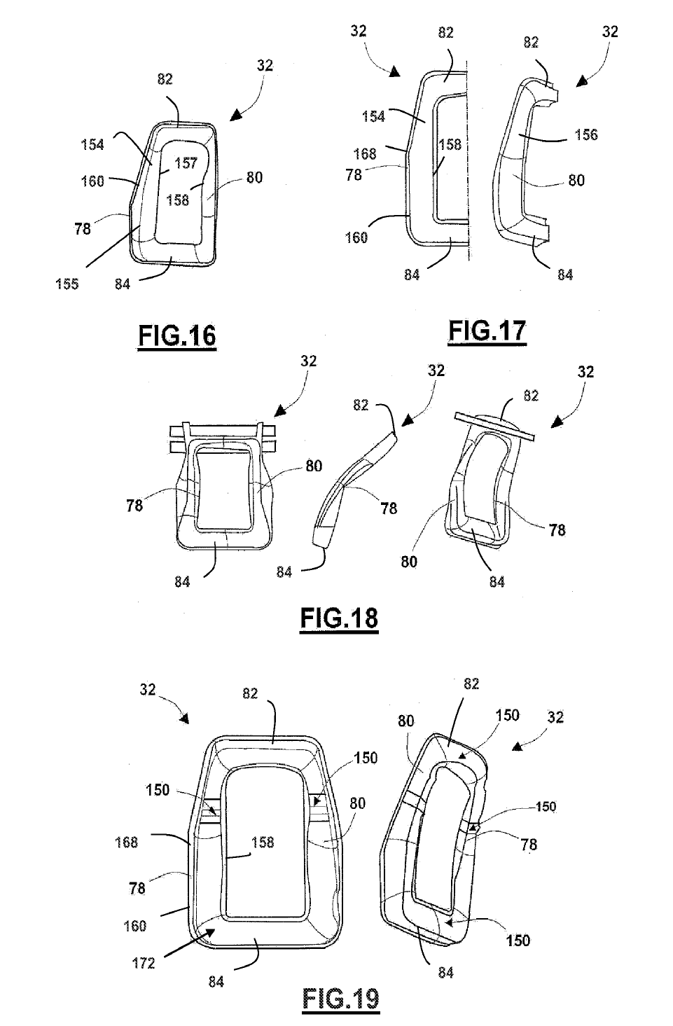

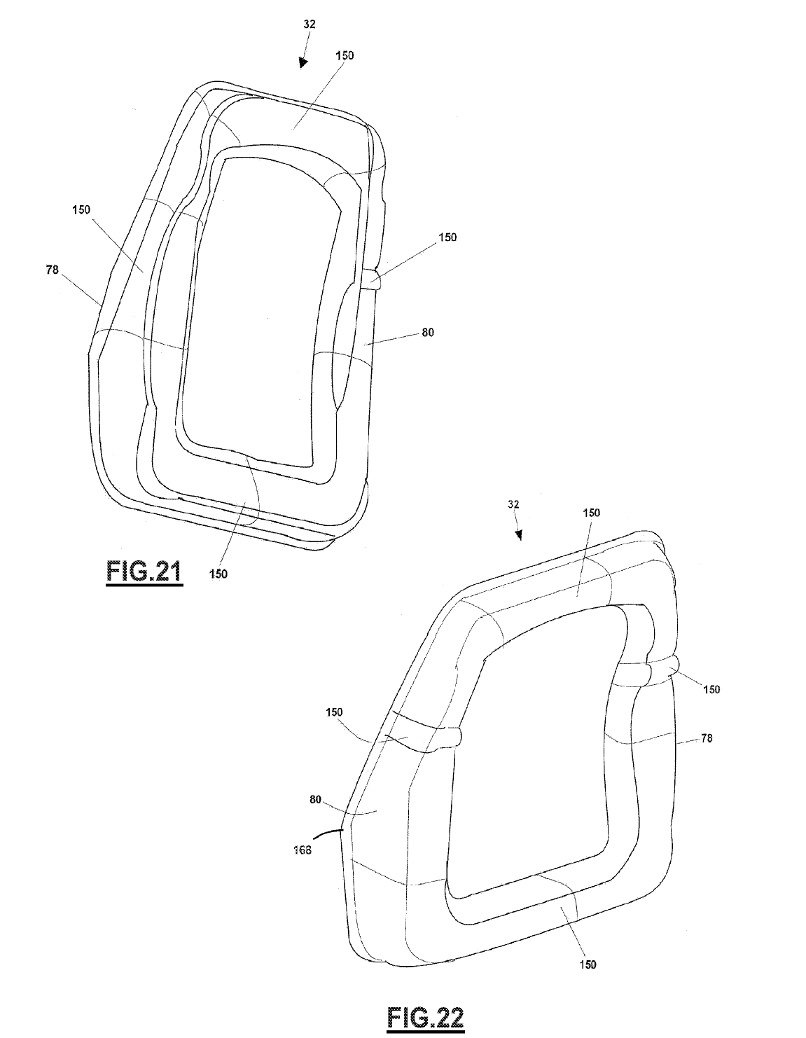

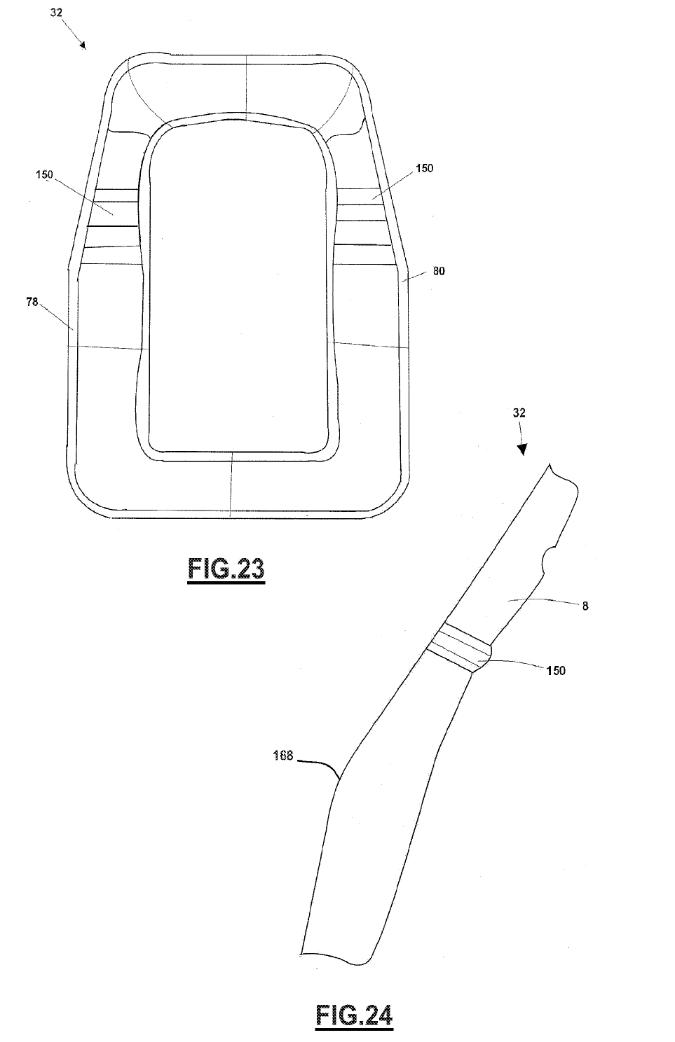

Referring generally to FIGS. 16 through 24, further exemplary embodiment of a one-piece back frame 32 is shown. The one-piece back frame 32 generally includes a first side member 78, a second side member 80, an upper cross member 82, a lower cross member 84, a front surface 154, and a rear surface 156. The one-piece back frame 32 also includes an inner side wall extending from the front surface 158 and an inner edge 155 and an outer side wall extending from the front surface 160 and an outer edge 157 to form and define a generally U-shaped channel or profile 172. The one-piece back frame 32 can also have a bend or portion 168 that is angled at a predetermined degree. In this example, the bend 168 is located on the first and second side members and between the upper and the lower cross member 82, 84. The one-piece back frame 32 is constructed from a material (e.g., 0.8 mm thick, TWIP material, or the like), as shown in FIG. 16. Under rearward loading cases (e.g., rear impact), the one-piece back frame 32 may experience a failure mode (e.g., buckling at the middle portion of the side members 78, 80, etc.), as shown in FIG. 17. Using a quick linear optimization tool or topography enables the identification of an optimal bead pattern to stiffen, strengthen, or increase rigidity of the back frame 32 to achieve higher load-carrying capacity in rearward loading cases, as shown in FIG. 18.

FIG. 19 shows still another example of a one-piece back frame 32. The one-piece back frame 32 includes a plurality of formations, such as rib/stiffeners, darts, beads, protrusions, elevations, depressions, deformations, stampings, or the like 150 formed within the back frame 32 to enhance the strength and rigidity performance of the seat back frame 32 without significantly increasing the mass thereof, as shown in FIGS. 21-24. The number, length, shape, width, dimensions, position, orientation, and the like, of the formations 150 may vary as appropriate and/or as needed to optimize strength and performance of the one-piece back frame 32.

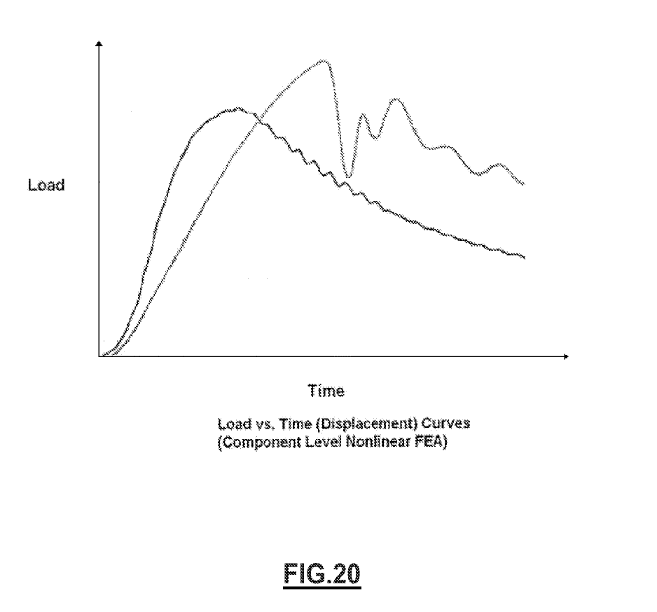

FIG. 20 shows a graph comparing the performance (load vs. time (displacement) of an improved one-piece back frame 32 versus a prior art design back frame. As shown in FIG. 20, the improved one-piece back frame 32 substantially outperforms the non-improved back frame by withstanding a significantly higher force/length over time. The improved back frame 32 has approximately 19% higher load-carrying capacity than the prior art back frame design without any impact on mass. In addition, the improved design shifts the buckling from the middle of the side members 78, 80 toward the bottom of the side members 78, 80 where recliner plates 152 are typically attached. This provides an opportunity to develop and employ other reinforcement solutions which could not be satisfactory in the current seat back frame design.

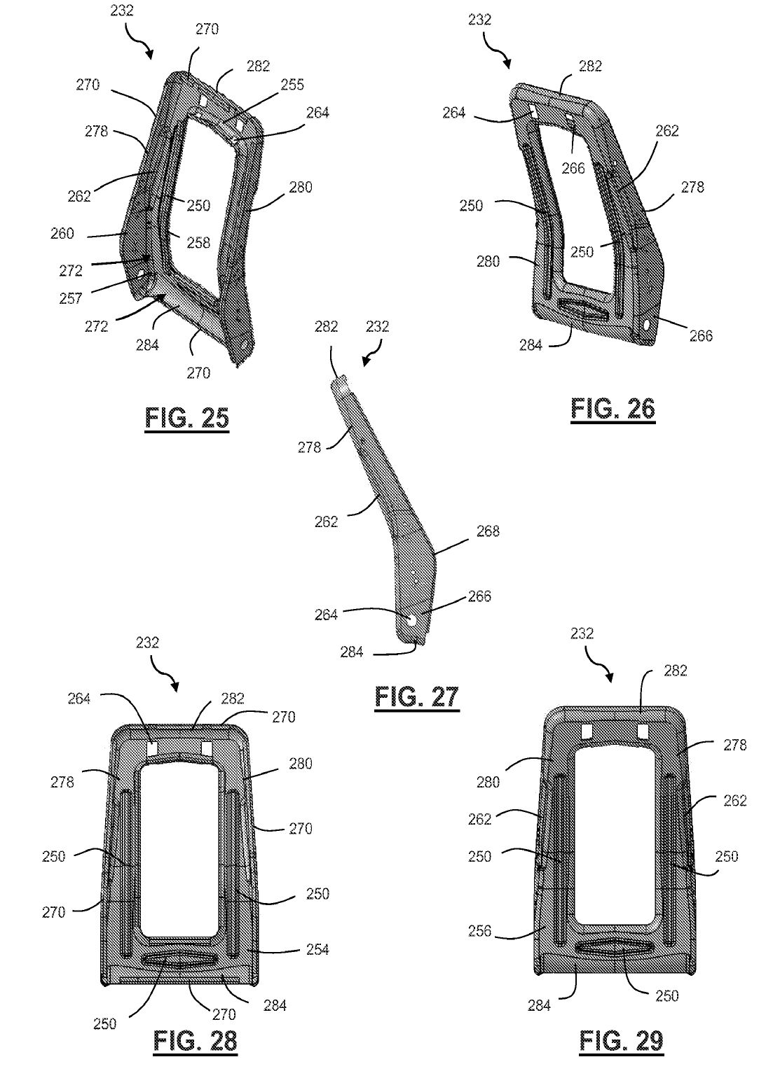

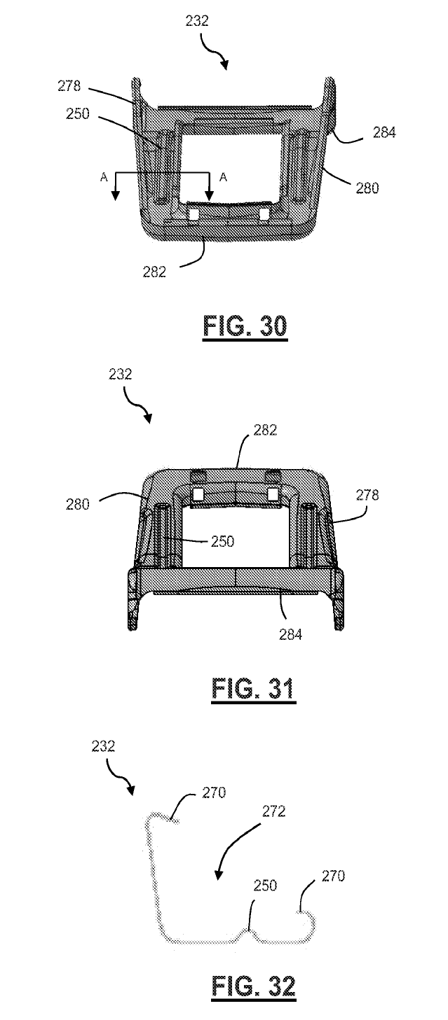

Referring now to FIGS. 25-32, a one-piece back frame 232 according to yet a further embodiment is shown. The one-piece back frame 232 generally includes a first side member 278, a second side member 280, an upper cross member 282, a lower cross member 284, a front surface 254, and a rear surface 256. The one-piece back frame 232 also includes an inner side wall 258 extending from the inner edge 255 of the front surface 254 and an outer side wall 260 extending from the outer edge 257 of the front surface 254 to form and define a generally U-shaped channel or profile 272. The one-piece back frame 232 can also have a bend or portion 268 that is position on a portion of the one-piece back frame 232 and that is angled at a predetermined degree. In this example, the bend 268 is located between the upper and the lower cross member 282, 284. The one-piece back frame 232 also includes a plurality of formations such as or rib/stiffeners, beads, darts, protrusions, elevations, depressions, deformations, stampings, or the like 250, 262 formed within the back frame 232 to enhance the strength and rigidity performance of the seat back frame 232 without significantly increasing the mass thereof. The number, length, shape, width, dimensions, position, orientation, and the like, of the formations 250, 262 may vary as appropriate and/or as needed to optimize strength, stability and performance of the one-piece back frame 232. In this example, a vertical rib 250 is disposed on a portion of the first and second side member 278, 280 to enhance the fore/aft stiffness of the one-piece back frame 232 and a horizontal rib 250 is disposed on a portion of the lower cross member 284 for managing side loads. The complexity of these ribs (formations) 250 can vary depending on the type of material used (generally, the complexity of the geometries can be increased with the use of lower strength material). In this example, a dart structure 262 is formed at the corner edge of the first and second side members 278, 280 (at the base of the outer side wall) to provide stability of the back frame walls. The one-piece back frame 232 may also include a plurality of apertures 264 (holes, extruded holes, openings, grooves, channels, or the like) and interface/surface areas 266 for attachment of other components, such as, recliner mechanism, recliner plates, recliner shaft, foam, trim covers, head restraints, or the like. The one-piece back frame 232 may also include a plurality of edges or flanges 270 disposed along or extending from the inner and outer side walls 158, 160 that provide stiffness to the structure, durability for the seat foam/upholstery, reduced sharp edges, and attachment/resting surfaces for other components, such as, foam, trim cover, or the like.

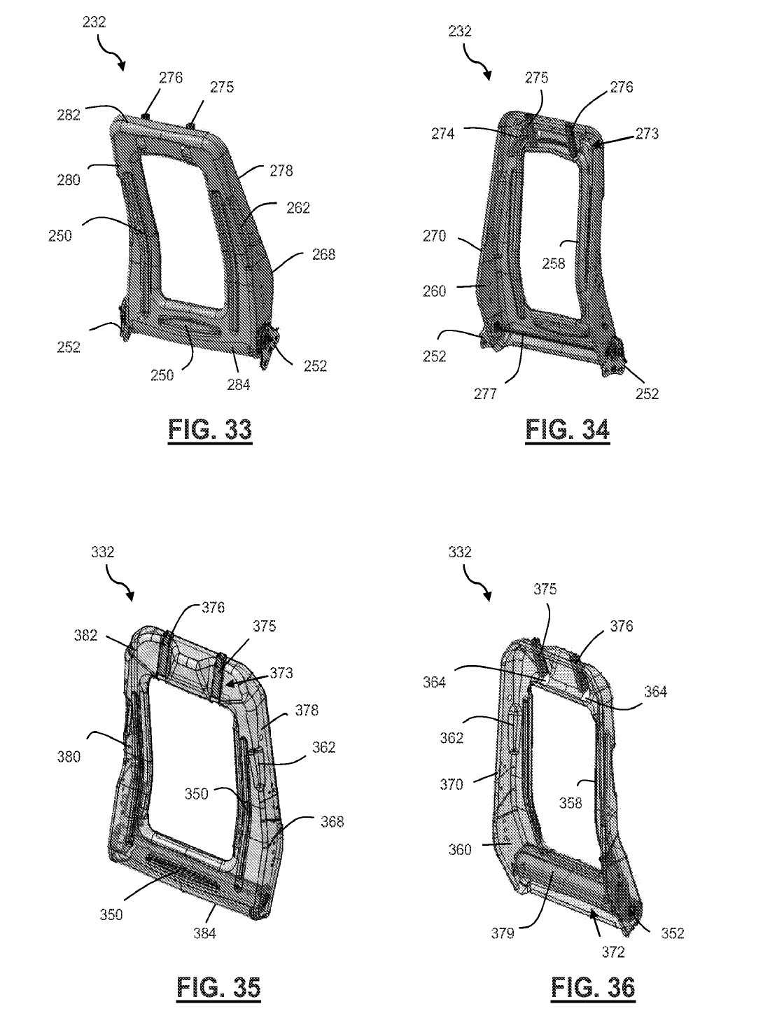

Referring now to FIGS. 33 and 34, a one-piece back frame 232 including a head restraint attachment assembly 273 is shown. The one-piece back frame 232 generally includes the features of the one-piece back frame disclosed in FIGS. 25-32. The head restraint assembly 273 includes a bracket member 274 and a first and second head restraint tube 275, 276, such as tubular shaft, extension, rod, head restraint rod receiving member, or the like for coupling to a corresponding head restraint rods, shafts, or the like. The bracket member 274 is generally an elongated member disposed within a portion of the channel of the upper cross member 282. The first and second tube 275, 276 include a first end coupled to the upper cross member 282 and a second end extending upwardly from the top of the upper cross member 282. The bracket member 274 secures the first and second shaft 275, 276 in a desired position and to the upper cross member 282 and also provides additional strength and stiffness to the upper cross member 282. A pair of recliner plates 252 is attached to the attachment interface/surface areas 266 and apertures 264 of the first and second side members 278, 280. A recliner shaft 277 connects the recliner plates 252 together.

Referring now to FIGS. 35 and 36, a one-piece back frame 332 including a head restraint attachment assembly 373 is shown. The one-piece back frame 332 generally includes the features of the one-piece back frame disclosed in FIGS. 25-32. In this example, the upper cross member 382 includes a pair of holes (e.g., extruded holes, or grooves, or the like) for inserting, attaching, and securing the first and second head restraint shafts 375, 376 therethrough such that the first and second head restraint shafts 375, 376 extend upwards towards the top of the upper cross member 382. In this example, the one-piece back frame 332 also includes a reinforcement member 379 that is position in the U-channel 372 of the lower cross member 384. The reinforcement member 379 aids in managing side loads and increases the strength and performance of the one-piece back frame 332.

The one-piece seat structures disclosed can be formed from various materials, such as, tailor welded blanks, tailor welded coils, monolithic blanks or coils having uniform material grade and thickness, or the like. The one-piece seat structures can be formed from a variety of steel grades and types, such as, HSLA, AHSS (Dual Phase, Complex Phase, TRIP, post form heat treatable steel (such as, aluminum, magnesium, etc.) or the like. The materials used can be optimized depending on various factors, such as, the type of structure or portion to be made, the location of the structure or portion, the geometry requirements of the structure or portion, the strength requirements of the structure or portion, or the like. For example, lower strength materials typically have higher formability which enable incorporation of more (or higher complexity) geometry in the design of a structure or portion, but may require greater thickness to recover strength lost by using lower strength material. The formability and strength of the material can be optimized and balanced according to the needs dictated by the type of structure or portion and its location within the seat assembly.

It is important to note that the construction and arrangement of the one-piece seat structure as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Further, the one-piece seat structure may include additional features that are conventionally known for a vehicle seat. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Many modifications and variations of the present disclosure are possible in light of the above teachings. Therefore, within the scope of the appended claim, the present disclosure may be practiced other than as specifically described.

What is claimed is:

1. A one-piece seat back frame for use in a vehicle seat assembly, the one-piece seat back frame comprising:
a first side portion and a second side portion spaced apart and parallel to one another, the first side portion having a first and second end and the second side portion having a first and second end;
an upper cross portion having a first end and a second end, the first end coupled to the first end of the first side portion and the second end coupled to the first end of the second side portion;
a lower cross portion having a first end and a second end, the first end coupled to the second end of the first side portion and the second end coupled to the second end of the second side portion; and
an inner wall extending from a front surface and an inner edge of the back frame, and an outer wall extending from the front surface and an outer edge of the back frame, thereby forming a U-shaped channel on the front surface wherein the back frame is formed from a monolithic blank material having uniform material grade and thickness.

2. The one-piece seat back frame of claim 1, further comprising a plurality of formations formed in the back frame to strengthen and stiffen the back frame.

3. The one-piece seat back frame of claim 2, wherein the plurality of formations includes a rib formed vertically along a portion of the first side portion and a rib formed vertically along a portion of the second side portion to strengthen and stiffen the first and second side members; and a rib formed horizontally along a portion of the lower cross member to strengthen and stiffen the lower cross member.

4. The one-piece seat back frame of claim 3, wherein the plurality of formations includes a corner rib formed on a portion of the corner edge between the first side member and the outer side wall and a corner rib formed on a portion of the corner edge between the second side member and the outer side wall to strengthen, stiffen, and stabilize the back frame.

5. The one-piece seat back frame of claim 1, further comprising a plurality of flanges extending from the edge of the outer and inner side walls.

6. The one-piece seat back frame of claim 1, further comprising a plurality of apertures for attaching seat components.

7. The one-piece seat back frame of claim 1, wherein the first and second side members include a bent portion such that a portion of the back frame is bent rearward a predetermined angle.

8. The one-piece seat back frame of claim 1, further comprising a bracket member coupled to the upper cross member and a pair of head restraint tubes coupled to the bracket member, the bracket member for securing the head restraint tubes thereto and providing additional strength to the upper cross member.

9. The one-piece seat back frame of claim 1, further comprising a reinforcement member disposed on the lower cross member between the first and second side member, the reinforcement member for strengthening the lower cross member.

10. A one-piece seat structure for use in a vehicle seat assembly, the one-piece seat structure comprising:
a first portion formed from a first material grade and having a first material thickness;
a second portion formed from a second material grade and having a second material thickness; and
wherein first and second portion are coupled together to form a tailor welded blank and the one-piece seat structure is formed from the tailor welded blank using a cold-forming process.

11. The one-piece seat structure of claim 10, further comprising a plurality of formations formed in the seat structure to strengthen and stiffen the seat structure.

12. The one-piece seat structure of claim 11, wherein the plurality of formations includes ribs formed in the seat structure to strengthen and stiffen the seat structure.

13. The one-piece seat structure of claim 10, wherein the one-piece seat structure is one of a seat back, a seat back frame, a seat back side member, a seat back cross member, a seat base, a seat base frame, a seat base side member, a seat base cross member, and a seat pan.

14. A method of forming a one-piece seat structure, the method comprising the steps of:
providing a first portion of material formed from a first material grade and having a first material thickness;
providing a second portion of material formed from a second material grade and having a second material thickness;
forming a tailor welded blank by coupling the first portion to the second portion; and
forming the one-piece seat structure from the tailor welded blank using a cold-forming process wherein the one-piece seat structure includes a first side portion and a second side portion spaced apart and parallel to one another, the first side portion having a first and second end and the second side portion having a first and second end, an upper cross portion having a first end and a second end, the first end coupled to the first end of the first side portion and the second end coupled to the first end of the second side portion, a lower cross portion having a first end and a second end, the first end coupled to the second end of the first side portion and the second end coupled to the second end of the second side portion and an inner wall extending from a front surface and an inner edge of the back frame, and an outer wall extending from the front surface and an outer edge of the back frame, thereby forming a U-shaped channel on the front surface wherein the back frame is formed from a monolithic blank material having uniform material grade and thickness

15. The method of claim 13, further comprising the step of forming a plurality of formations in the seat structure to strengthen and stiffen the seat structure.
